(19) United States
(12) Patent Application Publication
(10) Pub. No.: US 2022/0392172 A1
(43) Pub. Date: Dec. 8, 2022

(54) Augmented Reality App and App Development Toolkit

(71) Applicants: Scott Focke, Argyle, TX (US); Brent Ashton, Lakewood Village, TX (US)

(72) Inventors: Scott Focke, Argyle, TX (US); Brent Ashton, Lakewood Village, TX (US)

(21) Appl. No.: 17/412,193

(22) Filed: Aug. 25, 2021

Related U.S. Application Data
(60) Provisional application No. 63/070,235, filed on Aug. 25, 2020.
(60) Provisional application No. 63/087,837, filed on Oct. 5, 2020.

(51) Int. Cl. G06T 19/00; G06V 30/224; G06V 20/20; G06F 8/20; G06V 20/64; G06V 20/00; G06V 30/42

(52) U.S. Cl. CPC G06T 19/006; G06V 30/224; G06V 20/20; G06F 8/20; G06V 20/647; G06V 20/36; G06V 30/42

(57) ABSTRACT

An augmented reality method using a mobile device having a display screen and a camera, the method includes receiving an image of a physical object from the camera, the physical object incorporating a machine-readable code, detecting the machine-readable code in the image of the physical object, decoding the machine-readable code, determining a website address of a website in response to decoding the machine-readable code, automatically navigating to the website according to the website address, and automatically receiving a video stream from the website and playing the video on the display screen of the mobile device superimposed over the image of the physical object.

### RELATED APPLICATIONS

This application claims the benefit of U.S. Provisional Application No. 63/070,235 filed Aug. 25, 2020 and U.S. Provisional Application No. 63/087,837 filed Oct. 5, 2020, which are incorporated by reference in their entirety.

### FIELD

The present disclosure relates to the field of augmented reality, and in particular, to an augmented reality web and mobile app and app development toolkit.

### BACKGROUND

Augmented reality (AR) is an interactive experience of a real-world environment where the objects that reside in the real world are enhanced by computer-generated perceptual information across one or more sensor modalities, including visual, auditory, haptic, somatosensory, and olfactory. This experience is typically interwoven with the physical world such that it is perceived as an immersive aspect of the real environment. In this way, augmented reality alters or enhances one's sensory perception to bring aspects of the virtual world into the user's perception of the real-world environment.

### BRIEF DESCRIPTION OF THE DRAWINGS

FIG. 1 shows an example physical flyer, viewed through an onboard camera of a mobile device, that may be used to trigger an augmented reality experience of a user according to the teachings of the present disclosure;

FIGS. 2-6 show examples of images displayed on a mobile device screen during the augmented reality process according to the teachings of the present disclosure;

FIGS. 7-9 is a flowchart of the augmented reality process according to the teachings of the present disclosure;

FIG. 10 is a simplified block diagram of a computing environment for implementing the augmented reality process according to the teachings of the present disclosure;

FIG. 11 is a simplified block diagram showing some of the available menu and scene selection templates of the AR development toolkit according to the teachings of the present disclosure;

FIGS. 12-17 are examples of screen displays of the menu and functionality templates of the AR development toolkit according to the teachings of the present disclosure; and

FIGS. 18-21 is a simplified flowchart showing process flow of the AR development toolkit according to the teachings of the present disclosure.

### DETAILED DESCRIPTION

The augmented reality (AR), mixed reality (MR), and virtual reality (VR) technology described herein includes a web browser and mobile app-based method that uses augmented reality to present information for primarily advertising and marketing of goods and services. The augmented reality process described herein presents information and images by displaying them on the screen of a mobile device (or field of view) that shows them overlaid on top of or otherwise having a realistic relationship with physical real-world objects. Further, to facilitate ease of app development, maintenance and updates, the AR app development toolkit described herein uses a repository of premade systems that can be readily altered to create new applications that results in greatly reduced AR app development time. A variety of devices and input types are supported by the toolkit as means to interact with premade and custom-made content. Two repositories are provided for the toolkit, one built in the Unity Engine, primarily using the C# programming language, and the other built primarily using JavaScript, HTML, and CSS for browser-based applications. The most notable difference in user-experience between applications built with these repositories is that apps created with the Unity version is to be downloaded and installed on the user's device, while the browser version does not, but does require an internet connection to function.

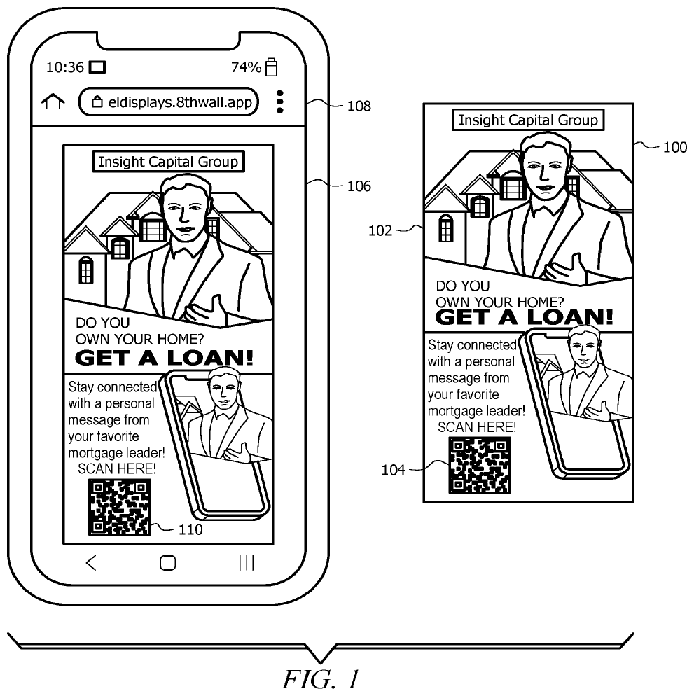

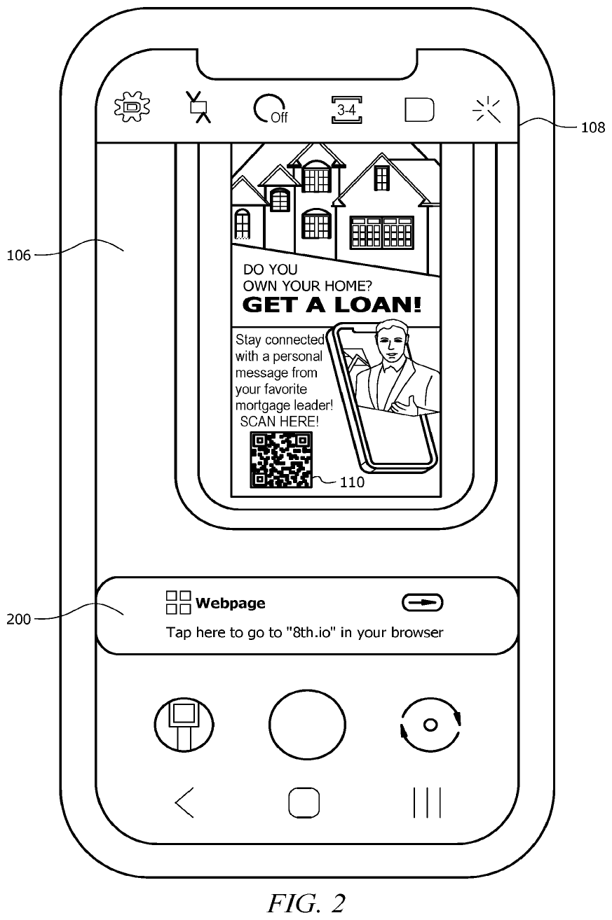

FIG. 1 shows an example of a 2-D object 100 with representative graphics or images 102 printed on one or both sides (defined planes). The 2-D object is, for an example, an advertising flyer 100 that may be mailed, handed to, or otherwise distributed to a target audience who may be potential customers of goods and services being promoted by the flyer. The graphics printed on the flyer 100 includes machine-readable code 104, such as a bar code, a QR code, or another suitable machine-readable pattern. When viewed through a camera or any suitable imaging device onboard a mobile device 108, the image of the flyer 100 is displayed on a display screen 106 of the mobile device 108, including an image 110 of the machine-readable code (shown as a QR code). The scanner application executing in the mobile device 108 causes it to display a prompt 200 (FIG. 2) that asks the user if they want to navigate to a web address (e.g., URL) specified by the QR code using a web browser application executing on the mobile device. Upon receiving the user's input, the web browser navigates to the website specified by the QR code. At the specified website, the user is asked to download and install an AR-enabling mobile application. Upon receiving the user's approval, the AR app is downloaded and execution of the AR application may automatically begin.

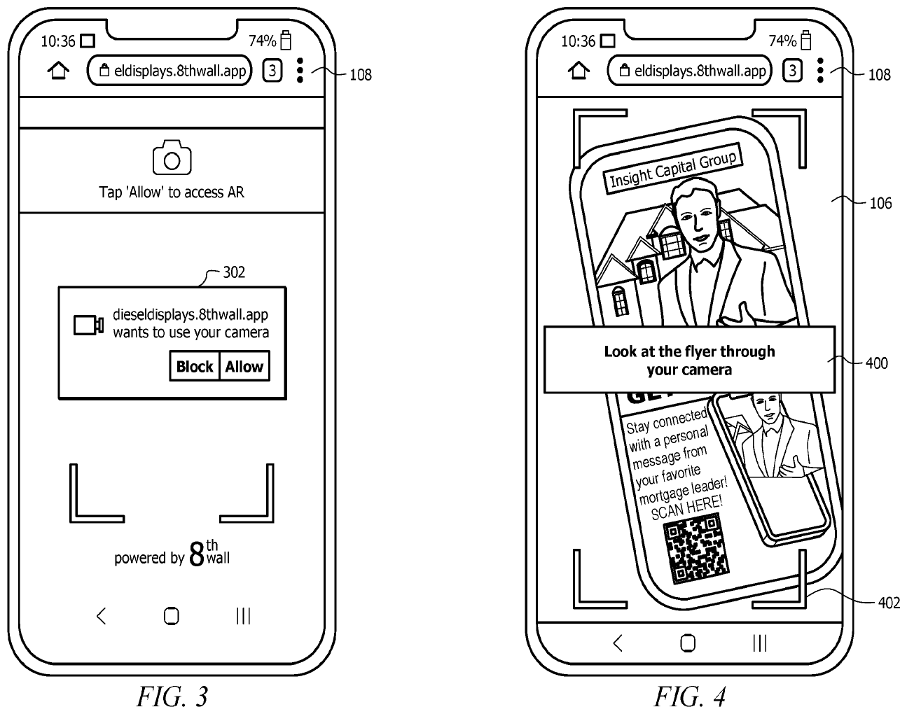

Users opening the AR mobile app for the first time are prompted (302) to allow the browser to access their camera (FIG. 3). In order for the AR app to function, it must be able to access the onboard camera or an imaging device of the mobile device 108. One or more inquiries for user permissions may be displayed on the screen of the mobile device 108 to solicit the required permissions. Pressing “Block” will prevent the AR app from working and instead display instructions for enabling the camera in order to proceed. Pressing “Allow” will enable the device camera and display a prompt 400 to instruct the user to point their device camera at the physical flyer, and to view the image of the flyer displayed on the screen 106 (FIG. 4).

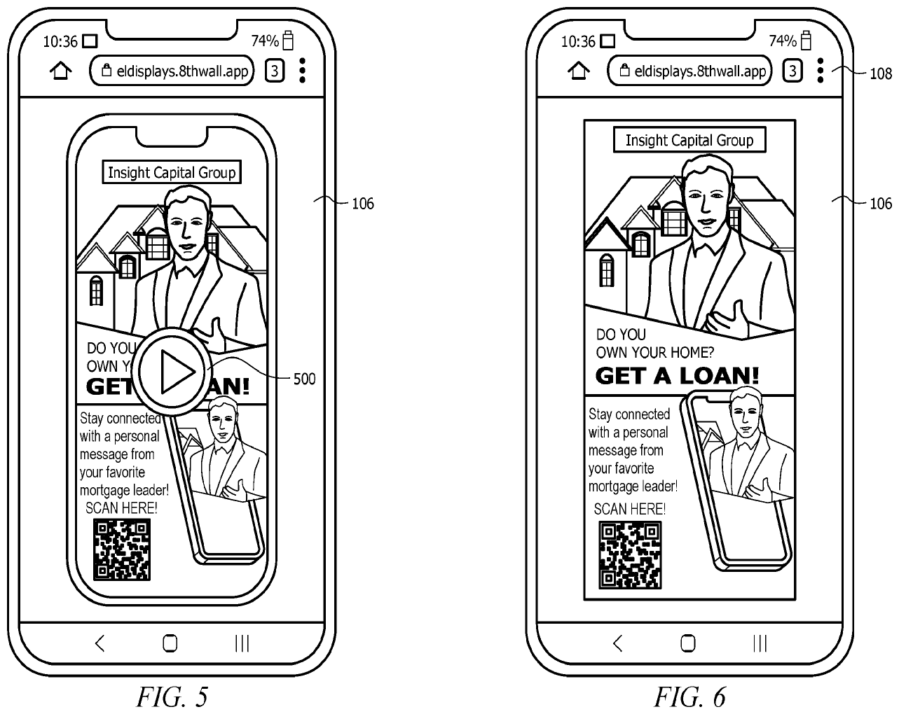

The AR app executing on the mobile device analyzes the image data from the camera and performs image recognition. Once the AR app recognizes or detects the anticipated image of the physical flyer 100, a prompt 400 is displayed on the screen, in this example, “Look at the flyer through your camera,” as shown in FIG. 4. Indicators 402, such as brackets shown in FIG. 4, may be displayed on the screen to guide the user to orient the mobile device properly so that the image of the flyer falls within the area defined by the bracket. As shown in FIG. 5, once the image of the flyer is properly oriented and displayed on the device screen, a play button 500 is shown superimposed over the image. Alternatively, the AR app may automatically initiate the AR sequence as soon as it detects the flyer image is properly oriented on the screen 106. When the user taps this play button 500, a video begins to play and superimpose moving images onto the scene displayed on the screen 106 as if the image printed on the static flyer 100 has come to life. For example, the static image of the gentleman on the physical flyer, when viewed by the user on the screen of the mobile device, is now animated with motions, gestures, and audio speech (e.g., FIG. 6). Until the video finishes playing, the user is able to pause and play the video by tapping the proper control icons with their finger, toggling the play/pause state. Other suitable controls may be available to the user. As long as the user is pointing the camera of the mobile device at the physical flyer 100, the AR effect is maintained until the video ends.

After initial image tracking of the flyer is established, if the device camera loses sight of the tracked flyer, the video object will attach itself to the user's device camera to remain in view. When the video finishes playing, a brief delay, such as a one second delay, elapses. After this delay, the user may be automatically redirected to a website that provides the user with additional information regarding subject matter discussed in the video. After the website is opened, the user experience is guided by the website.

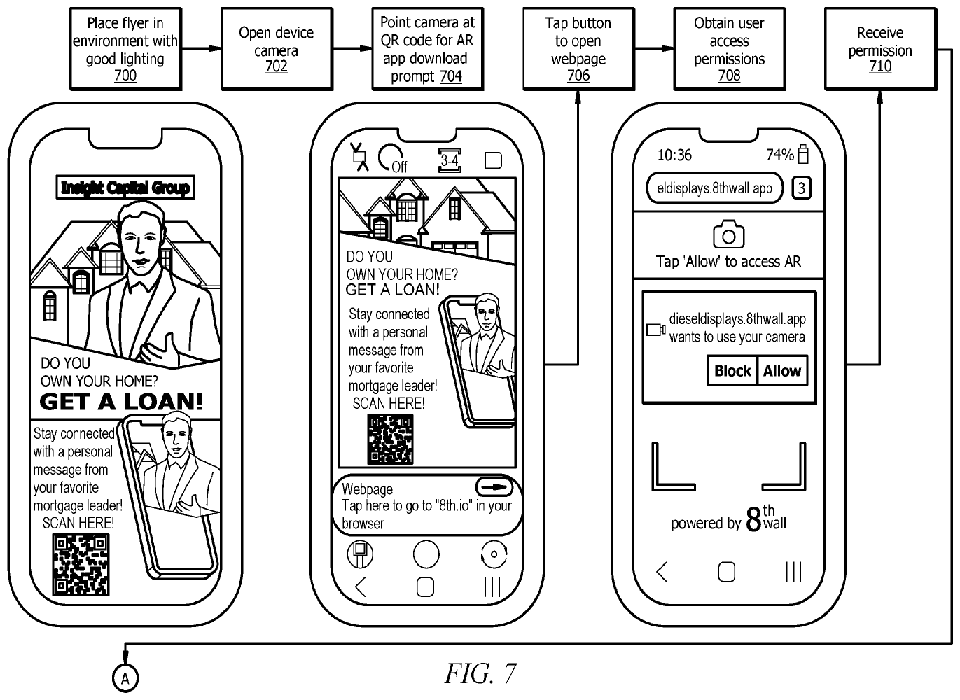

Referring to FIGS. 7-9, the augmented reality process flow is described in more detail. As shown in FIG. 7, the physical flyer (a 2-D object with at least one defined plane) is placed in the user's environment with sufficient lighting so that the images on the flyer can be easily perceived by the built-in camera of a mobile device (block 700). The device camera app is launched (block 702) and it is pointed at the image printed on the physical flyer so that the computer-readable code or QR code is visible and perceived (block 704), which leads to the launch of a web browser and the display of a web page (block 706). Depending on the setting of the mobile device, the perception of the QR code may automatically lead to the web site. The user may then be prompted to allow the web site and mobile app to access the user's camera app (blocks 708 and 710).

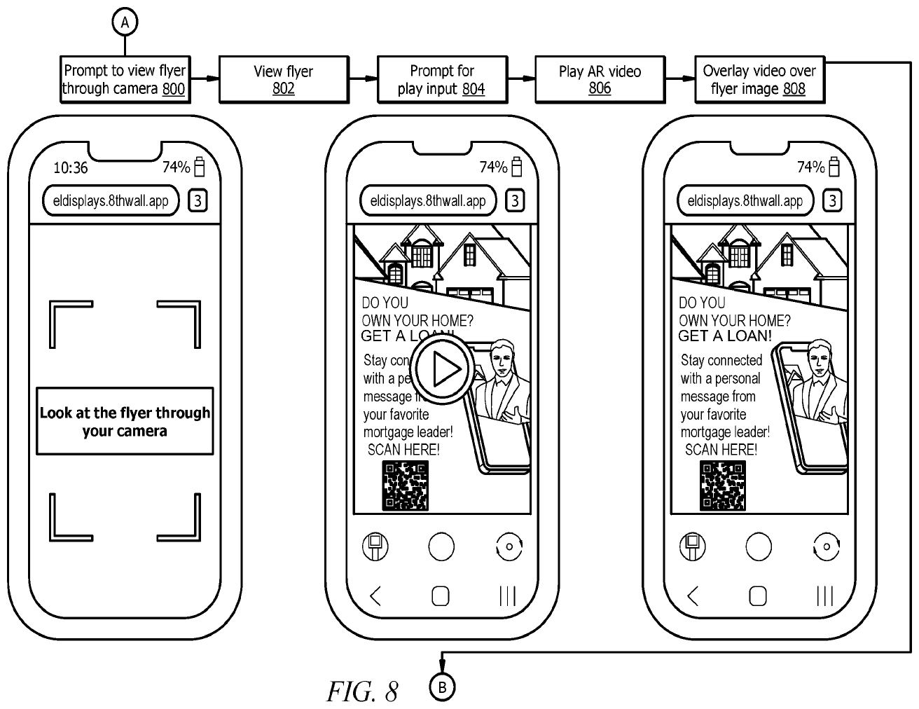

Referring to FIG. 8, the user is then prompted to point the device camera at the physical flyer and to view the physical flyer on the mobile device screen (blocks 800 and 802). The AR mobile app imposes the image of the flyer onto the device screen in the same size and orientation as in the real-world environment. A “play” button is displayed on the device screen and when the user taps the “play” button, it causes a video to be streamed from the website to the mobile device (blocks 804 and 806), and the image that is displayed on the screen becomes the video with moving images which may have audio components that are played via the mobile device speakers (block 808).

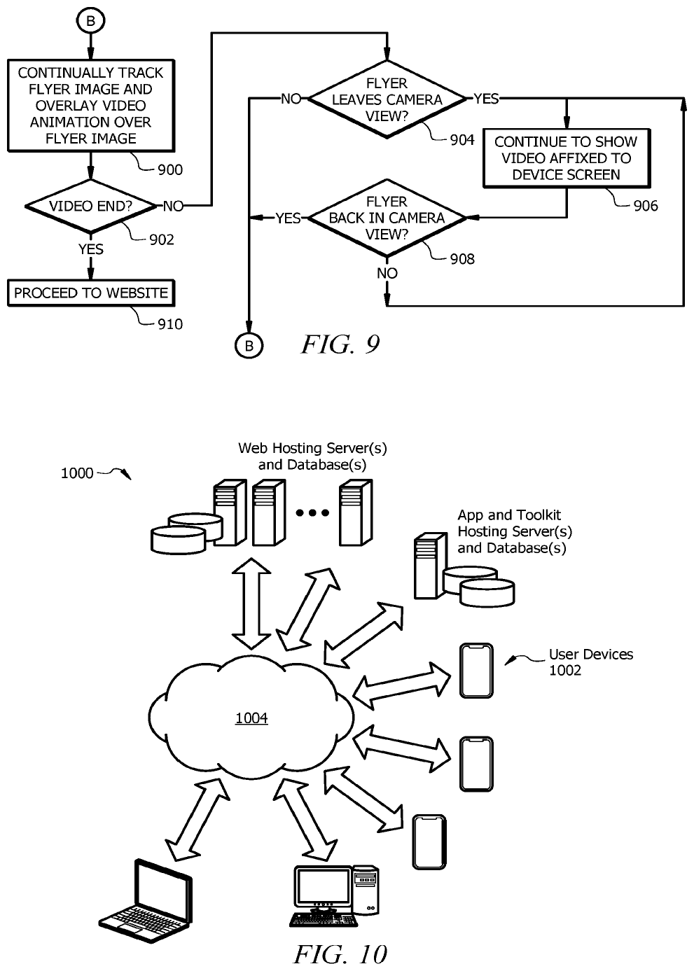

As shown in FIG. 9, the mobile app continually and dynamically analyzes and tracks the position, orientation, and perceived size of the physical flyer image as captured by the device camera, and superimposes the video onto the device screen as if the video images are being displayed on the actual paper flyer (block 900). The mobile app proceeds in this manner until the video ends, as detected in block 902. If the video has not ended, the mobile app also continually to detect whether the flyer has left the device camera image, i.e., whether the user has moved the mobile device so that the physical flyer is no longer in the field of view of the device camera (block 904). If the physical flyer is no longer within the field of view of the camera (the flyer is no longer part of the captured image of the device camera), the mobile app continues to show the AR video affixed on the device screen but preferably occupying the entire screen (block 906). The mobile app continues to monitor the captured image of the device camera to determine whether the flyer is now back in the field of view (block 908). If the flyer is now part of the captured image of the device camera, the mobile app may now superimpose the AR video back over the image of the flyer as before (block 900), until the mobile app detects that the video has ended (block 902). Once the video ends, an option is to allow the web browser to advance to a particular web page or web site where the user may peruse additional information related to the subject matter of the AR video. As described above, while the video is being displayed, the user may pause the video.

Referring to FIG. 10, the web pages of the web site are hosted on one or more web servers 1000, and the mobile app for user download may be hosted on the same or different servers, and may be hosted by third-party hosting services. The AR development toolkit and associated databases, to be described below, are also be hosted on one or more Internet-enable servers. The servers are accessible to the user's devices 1002 via WiFi, local area network, and/or the cellular network through the internet or global computer network 1004. The user devices 1002 may include any computing device that can be operated by a user, including mobile phones, laptops, notepad computers, desktop computers, wearable devices, and devices especially designed to enhance augmented reality (AR), mixed reality (MR), and virtual reality (VR) experiences.

It should be noted that the QR code that is used to trigger the augmented reality session can be any form of computer-readable code or image that can be perceived by the camera app. Further, the printed flyer is only one example of the physical carrier for the QR code. Any suitable surface that may carry a static image can be used to initiate the AR experience. Other examples of the physical carrier may include business cards, newspaper ads, postcards, posters, signage, billboards, product labels, product packaging, package inserts, user manuals, pet ID tags, personal IDs, company badges, and clothing tags.

The mobile app described above may be implemented, maintained, and updated by using an AR app development toolkit described below. To facilitate ease of app development, maintenance and updates, the AR app development toolkit uses a repository of premade systems and devices, including templates, that can be readily deployed and tailored to create new AR mobile applications that results in greatly reduced development time. A variety of devices and input types are supported by the toolkit as the means to interact with premade and custom-made content. Two repositories are provided for the toolkit, one built in the Unity Engine, primarily using the C# programming language, and the other built primarily using JavaScript, HTML, and CSS for browser-based applications. The most notable difference in user-experience between applications built with these repositories is that apps created with the Unity version are to be installed on the user's device, while the browser version requires an internet connection in order to download the app to the user's device. The AR development toolkit also uses a Unity Engine extension called Mixed and Augmented Reality Studio (MARS), which adds new functionality to support augmented and mixed reality content creation. MARS provides a set of companion apps that provides the ability to address real-world objects.

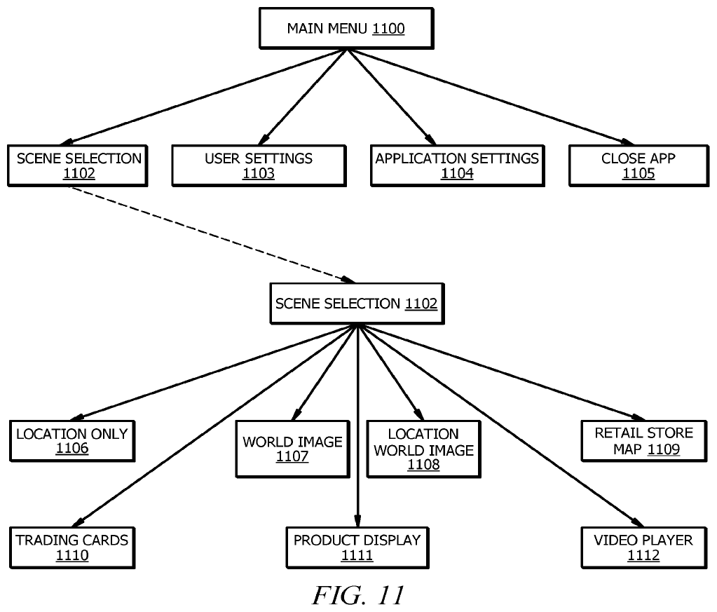

Hereinafter is a description of the AR development toolkit according to the teachings of the present disclosure. The term “developer” refers to the app developer who will be using the toolkit to develop AR mobile apps and the term “end user” refers to the user who will be using the AR mobile app. FIG. 11 shows an example architecture of the toolkit menu options. From a main menu 1100, the developer may selectively access a scene selection menu 1102, a user settings menu 1103, an application settings menu 1104, and a close app option 1105. In particular, from the scene selection menu 1102, the developer may select a number of schemes implemented in the toolkit in which to effect augmented reality or mixed reality scenes in the AR app, and these include: location only 1106, world-image 1107, location-world-image 1108, retail store map 1109, trading cards 1110, product display 1111, and video player 1112. More details of these AR schemes are described below.

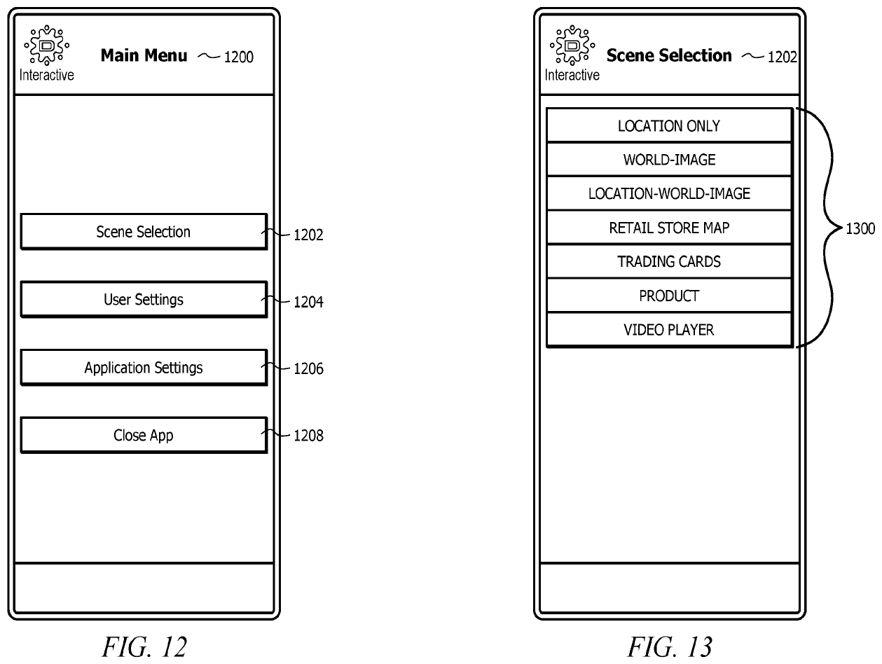

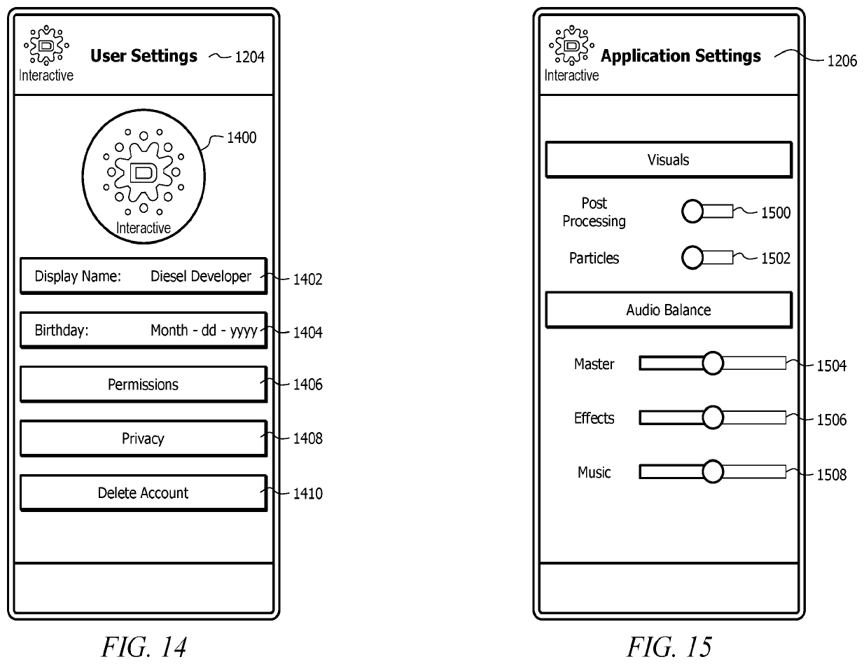

FIG. 12 shows an example of a Main Menu template 1200 provided by the toolkit. The Main Menu 1200 allows the developer to specify the first set of user interface elements to be displayed for viewing by an end user after the AR application finishes loading all necessary content. From the Main Menu 1200, the end user can click on various buttons 1202-1208 to open Scene Selection 1202 (FIG. 13), open their personal User Settings menu 1204 (FIG. 14), go to the Application Settings menu 1206 (FIG. 15), or close the mobile app 1208. Elements shared between FIGS. 12-15 include the project logo and the name of the displayed menu. The project logo can be changed by updating project settings visible to a developer. The name of the displayed menu is updated whenever a new menu is opened. All menus shown in the figures are templates which will be altered visually and, potentially, functionally when used to develop new AR applications.

FIG. 13 is the Scene Selection menu template 1202 that lists the AR scenes 1300 that are available to be used in the AR app. Tapping a button will preserve any information or content necessary from the active scene such as digital content associated with the user, save user data such as their progress in the active scene, and open the corresponding scene. The available AR scenes include (FIG. 11): location only 1106, world-image 1107, location-world-image 1108, retail store map 1109, trading cards 1110, product display 1111, and video player 1112.

The location only scene template 1106 is used in situations where given the GPS (global positioning system) location as an input data, and data associated with a detected or recognized plane in the real world image from MARS, an AR object may be placed on or affixed to the plane. The developer may upload or create a 2-D or 3-D AR object that is stored for the use by the AR app. The result of using the location only scene is the creation of an AR scene at a specified GPS location where an AR object appears to exist in the real-world scene. Therefore, the end user would see the AR object appear at the specified location having a relationship with a recognized plane such as affixed to a wall or placed on a tabletop.

The world-image scene template 1107 enables the AR app to receive and recognize a real-world (3D) image by comparing it to an image stored in an image database, and overlay an AR object in the scene upon an image match. The result of using the world-image scene is the creation of an AR scene when there is a match between a real-world image and an AR object is placed in the scene so that it appears to exist in the real world.

The location-world-image scene template 1108 enables the AR app to recognize a real-world image at a specified GPS location by comparing it to an image stored in an image database, and overlay an AR object in the scene upon an image match. The result of using the location-world-image scene is the creation of an AR scene when there is a match between a real-world image at a specified location, so that an AR object is placed so that it appears to exist in the real-world scene.

The retail store map scene template 1109 enables the AR app to display a map of the layout of an indoor location, such as a retail store, and to indicate the location of the end user on the map and/or other guidance functions. The location of the end user (mobile device) may be provided by an indoor positioning utility using GPS, WiFi, Bluetooth or other positioning technologies.

The trading cards scene template 1110 enables the AR app to receive and recognize a real-world trading card (e.g., a baseball card) by comparing its image to an image stored in a trading card image database, and overlay a video on the card upon an image match. Double-sided digital-2D objects are activated when a device camera detects the corresponding real-world card. Different behaviors can be associated with each side of the card. The result of using the trading card scene is the overlay a video (animated images and audio) or static image when there is a match between a real-world trading card and a stored image. This AR scene utility may be used for recognition of other types of 2-D images such as the flyer example described above, billboards, posters, signage, etc.

The product display scene template 1111 enables the AR app to receive a real-world image and recognize a plane on which to put or overlay the 3-D image of an AR object such as a product. The 3-D product images may be fetched from a separate product image database. As a result, the end user would see the 3-D image of a product positioned on or affixed to a surface so that it appears to exist in the real-world scene.

The video player scene template 1112 enables the AR app to overlay a video player in the real-world scene. The result of using the video player scene allows the end user to see a video to be displayed along with the video controls (e.g., play, pause, stop) This AR scene utility may be used for overlaying a video player over any scene or object. This object can be attached to the user's device screen, placed at a location in real-world space, or attached to a video target image, allowing this single video player object to function as an inline video player akin to a YouTube video, or replicate a TV screen in a digital environment. The toolkits provides for adjusting pixel count and aspect ratio to match playing video. Green screen effect is available, and vents can be connected to timestamps in a video.

In any of the scenes in which video or animated images are overlayed or placed into the scene, a further control functionality may be available. For example, the toolkit may enable the detection of the end user's face and automatically pauses video play when it detects that the end user has turned away from the mobile device screen.

FIG. 14 is the User Settings menu 1204 provided by the toolkit that contains user data and security options. The profile picture 1400, display name 1402, and birthday 1404 may not be included or needed in AR applications without social interaction. Permissions 1406 refers to the device sensors and features the AR application is designed to use. The Permissions 1406 required by the AR application will vary. Privacy 1408 refers to the way in which user data is submitted for analytics and in applications with social features, what other users can see. Privacy settings will not be available in applications that do not make use of user data or include social features. The Delete Account setting 1410 will allow or prompt end users for confirmation that they wish to delete their account. The data deleted by this action, if selected by the end user, will vary between applications.

FIG. 15 is the Application Settings menu 1206 provided by the toolkit, which contains setting options for visual and audio effects in the AR application. Users can adjust these A/V settings to balance visual and audio quality and performance. Post Processing 1500, when enabled, applies effects to a users' camera view after elements in a scene are rendered for artistic improvements that may be at the cost of device performance. Post-processing may be disabled to improve performance. Particles 1502, when enabled, refers to small particulates used to simulate smoke, sparks, or dust. Hundreds of particles may be used at once to achieve the desired effect and thus, can affect the overall performance of the processor. The user may also adjust the frequency of on-screen animations updating, and set the amount of desired visual fidelity. Master volume 1504 adjusts all audio in the application. Effects 1506 adjusts the volume of sounds played as a response to an event in the application such as when a user taps a button or activates a particle system. Music 1508 adjusts the volume of any musical tracks used in the AR app including ambient tracks and music played in response to an event.

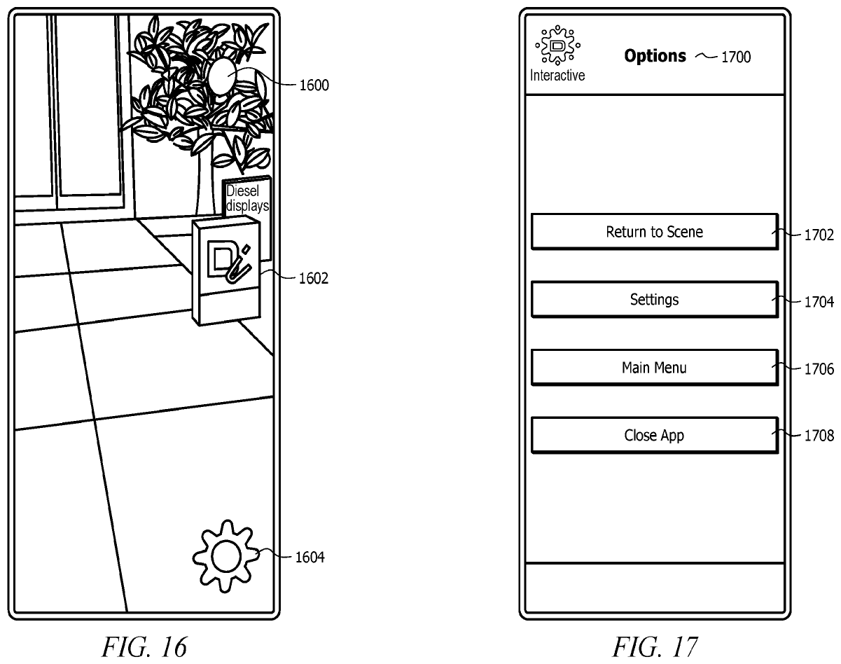

FIG. 16 is a screenshot of a marker-less augmented reality test scene example that positions an end user by way of the device GPS and compass. The camera view shows the real-world space the user is standing in. The compass visualization 1600 indicates the user's directional heading. When the red stripe on the compass points straight up toward the top of the screen, the user is facing North. The digital Diesel Interactive sign 1602 is placed in the digital world using real-world coordinates near the front door of Diesel Displays' building in Carrolton, Tex. When the user clicks on the scene options button 1604 opens a menu with options specific to the scene the user is in.

FIG. 17 is the Scene Options menu 1700. From this menu, users can return to the scene currently loaded 1702, open a settings menu specific to the scene currently loaded 1704, return to the main menu 1706, or close the app 1708. The Settings sub-menu 1704 will vary in appearance and functionality depending on the application and scene developed. FIG. 17 shows the menus and buttons available to the user while in a scene. Behaviors in the scene itself will vary between apps developed with the toolkit.

At each user interface panel, a back button or icon may be displayed to enable the user to navigate back to a previous user interface screen.

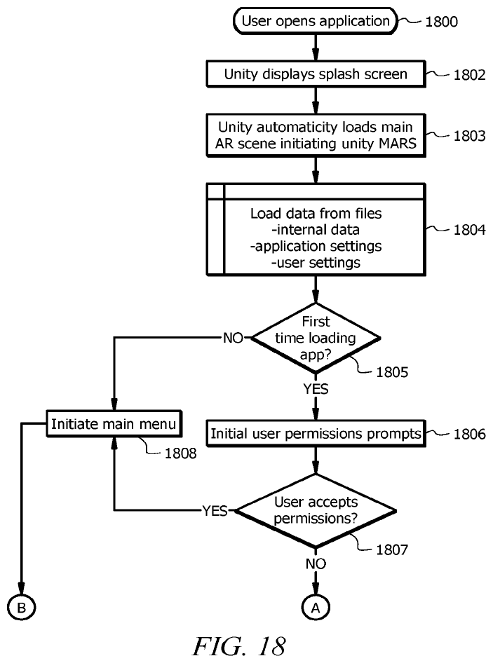

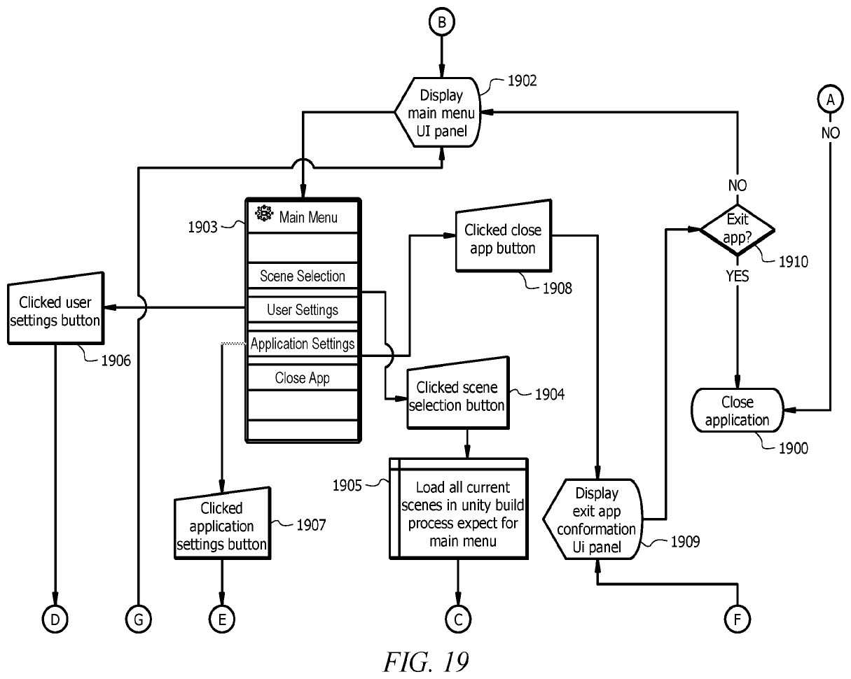

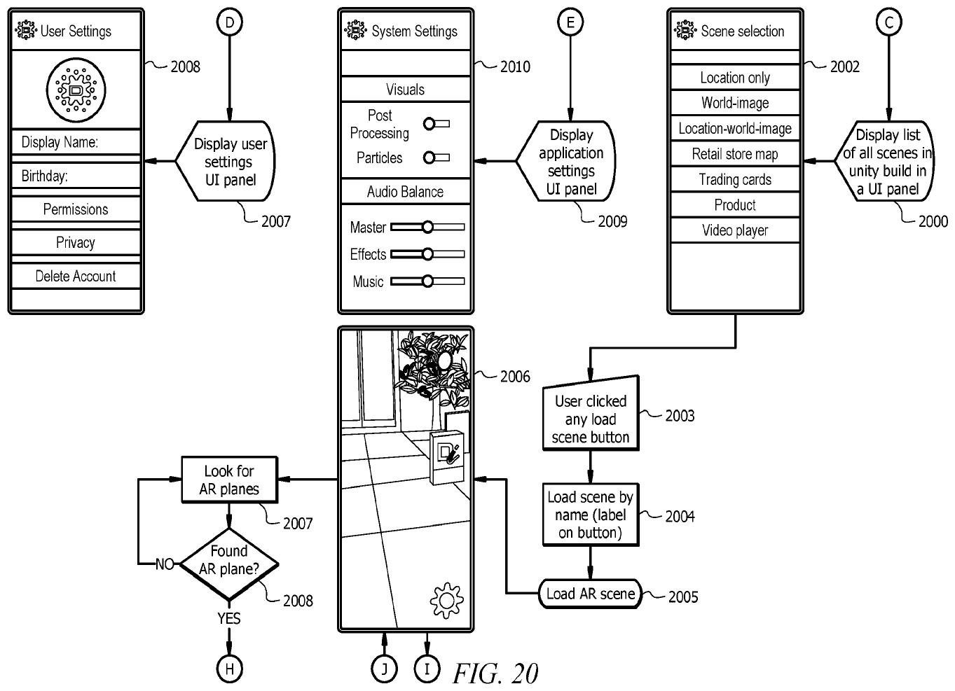

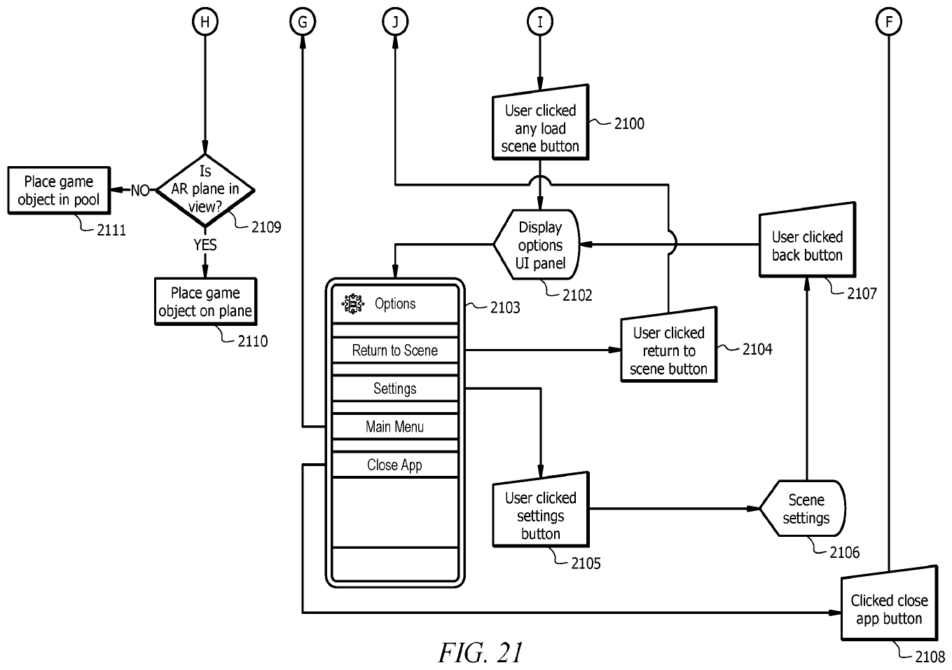

FIGS. 18-21 is a simplified flowchart showing how a developer accesses and navigates the toolkit to implement an AR application. User opens the application in block 1800, and the Unity Engine displays the splash screen (1802), and also automatically loads the main AR scene initiating MARS (1803). Further, internal data, application settings, and user settings are loaded from data storage or database into device memory for ready access (1804). If it is the first time that the application is being executed (1805), the user is prompted to give user permissions (1806). If the user does not give their permission for the application to access certain necessary data (1807), then the application execution is terminated (FIG. 19 block 1900). If it is not the first time the application is executed (1805), then the main menu is initiated (1808), and the main menu user interface panel (1903) is displayed (1902). From here, the user may selectively click on any button. If the user clicks on the scene selection button (1904), then all current scenes in the Unity Build process is loaded except for the main menu (1905). The list of all scenes in the Unity Build is displayed (2000) in the user interface panel (FIG. 20 block 2002). The available AR scenes include (FIG. 11): location only 1106, world-image 1107, location-world-image 1108, retail store map 1109, trading cards 1110, product display 1111, and video player 1112. From here, if the user clicks on any load scene button (2003), then the selected scene is loaded (2004 and 2005). An example AR scene is shown in block 2006. If the user clicks on any load scene button (2100), then the Options user interface panel (2103) is displayed (2102). If the user clicks on the return to scene button (2104) then the display returns to the AR scene (2006). If the user clicks on the Settings button (2105), then the scene settings are displayed (2106). If the user clicks on the back button (2107) then the user is returned to the Options user interface panel (2102). If at the Options screen (2103) the user clicks on the main menu button, then the screen display returns to the main menu (1902 and 1903). If the user selects the close app button at the Options user interface panel, then the application is shut down (2108).

Returning to the Main Menu user interface panel (1903), the second option is User Settings. If the user selects this option (1906), then the User Settings user interface panel is displayed (2007 and 2008), where the user may change the value of certain settings. The third option on the Main Menu (1903) is Application Settings. If the user selects this option (1907), then the Application Settings user interface panel is displayed (2009 and 2010), where the user may change the values of certain application settings. The fourth option on the Main Menu is Close App. If the user selects this option (1908), then a confirmation prompt is displayed (1909) and the application exits and closes (1910 and 1900).

Returning to the AR scene (2006), the MARS analyzes the real-world scene to detect AR planes (2007). Upon recognition of a plane (2008), and the AR plane is within the real-world image as viewed by the user, then the AR object or game object is placed or overlaid on the detected plane (2110). If at any time the MARS determines that the detected plane is no longer within view of the user (inside the real-world image), then the AR object is returned to the pool (device memory) to remain readily accessible (2111).

In the user experience example described herein, a user may use apps built for a mobile device's operating system or a web browser. Both examples are initialized by using a device camera to scan a QR code. When users open the website prompted by the QR code, two flow paths can follow depending on whether the user is using a browser-based app or a downloaded app. If the app is browser-based, the app will open in the user's browser. If the app is downloadable, users will be prompted to download, install, and open the app. Once the app is open in a browser or on the device, the app will enter its startup sequence, then its main loop. The users may be prompted to provide the necessary permissions for the app to access device sensors and functionality. Via the Main Menu, the user has access to settings for their own profile within the app and settings that control features about the app itself. Both of these user interface panels have different designs between apps depending on features necessary for that app. A button to close the application is present, which prompts the user to confirm their decision before closing the application.

The toolkit also provides for the background process responsible for updating the applications. The update process is a co-routine that starts running after the app finishes loading and continues to run until it is ended by another app function. This process is invisible to the user unless a user permission is needed, or a restart of the application is necessary. Content that is hosted externally on web servers, such as images or audio/video files can be updated without affecting the running application. Updates to the applications code, scenes, or assets built into an application require the app be closed and updated via the Apple App Store or Google Play store.

It should be noted that the QR code employed herein can be any form of computer-readable or detectable code or image that can be perceived by the computing device. It can even be, for example, one or more sounds (detectable or not detectable by humans) that can be “heard” or sensed by the computing device's microphone as an audio input.

It is contemplated that an application system includes support for multiple input types; touch(es); swipe/gesture detection; mouse, keyboard input; gamepad support; VR Gaze controls; VR Controller Support; GPS Position; compass Orientation; and device acceleration. The toolkit provides adaptive user interface panels that change displayed menu content to reflect available user inputs. In the case of VR input, users can make use of the ability to move menus between screen space where menus are suffixed to the user's vision and world space where menus sit at a point in 3D digital space the user can interact with using the position of their VR controllers or the location they are looking (gaze controls).

It should be contemplated that the adaptive user interface with support for multiple input types and alternative menu layouts for different input types. Menus can occupy a location in a 3-D rendered scene or be affixed to the screen-space of a device. Some user interface elements, such as the video player, will support both. Objects can transition between world-space and screen-space if this feature is supported for said object.

It is contemplated herein that AR Recognition from QR includes functional and working through a web-browser; A QR code can prompt users to open a website hosting a browser-based AR app; and opening the app is a multi-step process, requiring individual user permission prompts due to allowances/limitations on various Operation Systems. Constantly working on this function to verify whether it can be over-come in the future

It is contemplated herein that the toolkit enables the development of downloadable applications where a QR code can prompt users to open a website hosting a downloadable app installation file; the user is prompted to download and install the app; the user is prompted to give permission for device sensors and functions when the app runs on their device. Because the app is installed on their device, the user only has to grant permission once.

It is contemplated herein that users are able to unlock additional content by scanning QR codes using their device camera app and/or using the AR camera within an AR App.

It is contemplated herein that the toolkits provides a display animation control script that can be attached to any animated 3-D model, allowing that model to react to a variety of stimuli including user input, collision with digital objects, device movement, or any other stimuli detectable by the application. Further, a 3-D animation sequence may be combined with a video sequence. For example, when the user's device camera looks at a postcard, an animated digital 3-D model of that postcard is seamlessly placed on top of the real postcard. The card appears to open (3-D animation), and a digital video slides out of the opening and begins to play.

It is contemplated herein that the toolkit provides a scene management system for changing between Unity scenes. Efforts are taken to minimize the number of scene changes during runtime. When scene changes are required, the Scene Management disconnects persistent objects from scene objects in the current scene, unloads the current scene, then loads the new scene.

It is contemplated herein that the toolkit provides a content management and update system. Updates to some content within the app can be downloaded during runtime without requiring the user to close, update, and reopen the app. Users can delay or opt out of updates to some content. For example, visual updates or updates that may conflict with what they are doing during their current session. Feature updates that alter the app's programming will require closing and updating the app. Applications should cache data on user devices to improve load times and allow users to access apps when offline.

It is contemplated herein that the toolkit provides a video player with the following functionalities: transition between world-space and screen-space; pause/play functionality; adjust pixel count and aspect ratio to match playing video; green screen effect. Further, events can be connected to timestamps in a video. For example, a video displayed in world-space could be complemented by a water splash effect that appears in 3-D when an object hits water in the video.

It is contemplated herein that the toolkit provides an animation system that supports 3-D animation. Artistic 3-D animations and character animations are possible in both web AR and Unity AR. A script will handle animation transitions for animated sequences and characters which are reliant on user input.

It is contemplated herein that the toolkit provides a network multi-user environment that enables support for cross-platform multiplayer for local and server-based connections. This functionality may use Bluetooth and Wi-Fi for local connections. Server communication is required for users not sharing a local space.

It is contemplated herein that the toolkit provides augmented reality features that include: ability to track multiple images and 3-D objects in AR; ability to identify and track items placed by different users in AR (may require users to press button or scan the object they are about to set down, then ping other devices to identify and track said item but recognize another user's ownership of item); ability to see other users in AR. Uses a mix of GPS coordinates and devices sharing their world tracking and image tracking data; and system for target images with definitions of real space coordinates that can be used to re-orient the application and place users at more accurate GPS coordinates.

It is contemplated herein that the toolkit provides an image scanner (achieved with Vuforia) so that users can interact with real-world graphics by viewing them through their camera with an AR app open. Images recognized by the application will prompt a reaction from the application. The toolkit uses MARS to provide image recognition for determining the type of content displayed to users and use of tracked images as anchors for displaying content with greater stability than just world-tracking.

It is contemplated herein that the toolkit provides a world scanning tracking functionality (achieved with Vuforia). The device camera detects visual contrast in the environment. As the user moves the device, it is able to triangulate its position based on the time required for points of reference to move within the camera's field of vision. This allows the device to calculate precise movements in a digital AR scene. World scanning allows digital 3-D objects placed in the environment to interact with the real world to a limited degree.

It is contemplated herein that the toolkit provides application mod tools including digital world layout configuration that includes a tool accessible to developers and clients allowing them to place digital objects at real-world GPS coordinates, or connect digital objects to trackable images and trackable real-world spaces. The configuration files can be edited and loaded by the application to alter its behavior.

It is contemplated that to create an augmented reality system capable of transitioning between indoor and outdoor environments, the device camera, GPS, Compass, Accelerometer, and Gyroscope are used simultaneously to obtain an accurate real-world position and direction. With the combined tracking data, digital content can exist at real-world locations defined by developers or users. With the combined tracking data, users can move through the real and digital world similarly to how they would move through a virtual environment in a video game. The AR system supports tracking for multiple items simultaneously. Ability to identify and track items placed by different users in AR. May require users to press button or scan the object they are about to set down, then ping other devices to identify and track said item but recognize another user's ownership of item. Ability to see other users in AR may be provided, and function with a mix of GPS coordinates and devices sharing their point clouds. System for target images with definitions of real space coordinates that can be used to re-orient the application.

It is contemplated herein that the toolkit provides the following features available to users: limited behavior changes and configurable settings through in-app user interfaces.

In summary, the toolkit provides the ability to evoke an augmented reality experience for the end user that may be implemented by using a QR code (or another machine-detectable code) for the following applications: business cards, flyers, game cards, greeting cards, window displays, player cards (all professional and amateur sport teams), playing cards (for stats, game play, tutorials, etc.), souvenirs, food packaging, beverage packaging, toy packaging, books, gaming boards, retail packaging, wallpaper, event and performance tickets, signage, and web pages. The applications may be for augmented reality experiences for zoos, aquariums, amusements parks and rides, ball parks, stadiums, city, state, and national parks (to provide guidance, map, talk with virtual park rangers, etc.), car dealerships (interior, exterior, and engineering of cars), auto auctions (interior, exterior, and engineering of cars), museums, art galleries, apparel, shoes & accessories, (retail and wholesale), real-estate brokers/agents (for virtual tour of property), architectural firms (for virtual tour of property), interior design firms, real estate neighborhood developers (for virtual tour of neighborhood), and event organizers (to experience how events can look and feel).

The features of the present invention which are believed to be novel are set forth below with particularity in the appended claims. However, modifications, variations, and changes to the exemplary embodiments described above will be apparent to those skilled in the art, and the AR features and the AR app development toolkit described herein thus encompasses such modifications, variations, and changes and are not limited to the specific embodiments described herein.

What is claimed is:

1. An augmented reality method using a mobile device having a display screen and a camera, the method comprising:
receiving an image of a physical object from the camera, the physical object incorporating a machine-readable code;
detecting the machine-readable code in the image of the physical object;
decoding the machine-readable code;
determining a website address of a website in response to decoding the machine-readable code;
automatically navigating to the website according to the website address; and
automatically receiving a video stream from the website and playing the video on the display screen of the mobile device superimposed over the image of the physical object.

2. The method of claim 1, further comprising automatically superimposing an initial image matching the image of the physical object on the display screen of the mobile device prior to playing the video on the display screen.

3. The method of claim 1, further comprising beginning displaying the video on the display screen in response to receiving a user input.

4. The method of claim 1, wherein receiving an image of a physical object incorporating the machine-readable code comprises receiving an image of a 2-D physical object selected from the group consisting of flyers, business cards, trading cards, newspapers, postcards, posters, product labels, product packaging, and clothing tags.

5. The method of claim 1, wherein displaying the video on the display screen of the mobile device comprises automatically tracking the position and orientation of the physical object and maintaining the streaming video superimposed over the image of the physical object.

6. The method of claim 1, wherein detecting the machine-readable code in the image comprises detecting a QR code in the image.

7. A mobile app configured for execution on a mobile device to implement augmented reality, the mobile device having a display screen and a camera, the mobile app configured to:
receive an image of a physical object using the camera, the physical object incorporating a computer-readable code;
detect the computer-readable code in the image of the physical object;
decoding the computer-readable code;
determine a website address of a website in response to decoding the computer-readable code;
automatically receive from the website and superimpose an initial image matching the image of the physical object on the display screen of the mobile device; and
automatically receive a video stream from the website and displaying the video on the display screen of the mobile device superimposed over the image of the physical object.

8. The mobile app of claim 7, further configured to begin displaying the video on the display screen in response to receiving a user input.

9. The mobile app of claim 7, further configured to receive an image of a physical object incorporating the computer-readable code comprises receiving an image of a physical object selected from the group consisting of flyers, business cards, newspapers, postcards, posters, product labels, product packaging, and clothing tags.

10. The mobile app of claim 7, further configured to display the video on the display screen of the mobile device comprises automatically tracking the position and orientation of the physical object and maintaining the streaming video superimposed over the image of the physical object.

11. The mobile app of claim 7, wherein the computer app is configured to receive an image of a physical object using the camera, the physical object incorporating a QR code.

12. The mobile app of claim 7, wherein the computer app is configured to receive an image of a physical object using the camera, the physical object incorporating a predetermined pattern.

13. An augmented reality (AR) web-based and downloadable app development toolkit, comprising:
a plurality of user interface menu templates;
a plurality of AR scene templates adapted to provide treatment of at least one of a static 2-D image, static 3-D image, animated 3-D image, and a video overlay into a real-world scene viewed by a user via a camera onboard a mobile device in response to receiving input of at least global position system (GPS) location data, direction data, image of a physical object, detection of a plane, detection of a recognized image, detection of a recognized physical object, and orientation of the mobile device; and
support for at least one input type including touch, swipe/gesture detection, mouse input, keyboard input, gamepad, virtual reality (VR) Gaze control, VR controller, GPS location, compass orientation, and device acceleration.

14. The toolkit of claim 13, wherein the plurality of user interface menu templates comprise a main menu template, a user setting template, a system setting template, and a scene selection template.

15. The toolkit of claim 13, wherein the plurality of AR scene templates comprises a location scene template adapted to overlay an AR object onto a plane detected in a real-world scene at a specified GPS location.

16. The toolkit of claim 13, wherein the plurality of AR scene templates comprises a world-image scene template adapted to overlay an AR object into a real-world scene upon matching a real-world image with a stored image.

17. The toolkit of claim 13, wherein the plurality of AR scene templates comprises a location-world-image scene template adapted to overlay an AR object into a real-world scene upon matching a real-world image with a stored image at a specified GPS location, said AR object including a static 2-D image, static 3-D image, animated 3-D image, and a video.

18. The toolkit of claim 13, wherein the plurality of AR scene templates comprises a retail store map scene template adapted to overlay a map layout over a user's view of an interior space in response to location data.

19. The toolkit of claim 13, wherein the plurality of AR scene templates comprises a trading card scene template adapted to overlay an AR object retrieved from a database onto at least one side of a trading card in response to identifying images on the at least one side of the trading card, said AR object including a static 2-D image, static 3-D image, animated 3-D image, and a video.

20. The toolkit of claim 13, wherein the plurality of AR scene templates comprises a product scene template adapted to overlay a 3-D image of a product retrieved from a product database onto a detected plane in a real-world scene.

21. The toolkit of claim 13, wherein the plurality of AR scene templates comprises a video player scene template adapted to overlay a video player in the real-world scene being viewed by a user.
